(19) United States
(12) Patent Application Publication
(10) Pub. No.: US 2025/0372683 A1
(43) Pub. Date: Dec. 4, 2025

(54) PROCESS FOR SIMULTANEOUSLY PRODUCING HYDROGEN, ELECTRICITY, HYDROGEN PEROXIDE AND OXYGEN FROM WATER AND EQUIPMENT THEREOF

(71) Applicant: Fernando GALEMBECK, Campinas (BR)

(72) Inventor: Fernando GALEMBECK, Campinas (BR)

(21) Appl. No.: 18/872,842

(22) PCT Filed: Jun. 27, 2023
(86) PCT No.: PCT/BR2023/050216

§ 371 Date: Dec. 9, 2024

(30) Foreign Application Priority Data
Jun. 28, 2022 (BR) 102022012851-0
Jun. 16, 2023 (BR) 132023012012-0

(51) Int. Cl. H01M 8/0656; H01M 8/04791; H01M 8/0662

(52) U.S. Cl. CPC H01M 8/0656; H01M 8/04798; H01M 8/0687

(57) ABSTRACT

This invention was developed for the technical field of energy production, in which electricity and hydrogen are of great and growing importance. The only input used to produce electricity and hydrogen is water, and the production process is electrochemical, which occurs in a device that is electrified by the water itself. The process is based on the reaction of hydrogen abstraction from water, accompanied by the formation of hydrogen peroxide or oxygen, which occurs in a humid/aqueous environment that contains two electrical conductors separated, but electrically connected to an electrical circuit, with one conductor having a surface with an acidic nature (CA) and the other conductor with a basic nature (CB) of the substances present on the surfaces of the two electrical conductors.

### TECHNICAL FIELD

This patent application lies within the technical field of energy production, in which electricity and hydrogen are of great and growing importance. More and more economic sectors and activities are electrified, while the presence of hydrogen has always increased as energy vector and industrial raw material. In this invention, the input used to produce electricity and hydrogen is water, and the production process is electrochemical, which occurs in a device that is electrified by the water itself. Hydrogen peroxide and oxygen are formed as by-products, which are also important industrial raw materials, in addition to being widely used in the health field.

### STATE OF THE ART AND PROBLEM SOLVED

Obtaining energy from environmental water has already been announced on many different occasions, in countless ways. However, despite always discredited by theoretical claims, it was described in the invention that gave rise to patent applications PI0905342-5, CI0905342-5 and WO2011072348A1. The practical demonstration thereof was published for the first time in 2010, in a scientific article that experimentally demonstrated the spontaneous electrification of asymmetric capacitors formed by two different metallic electrodes in humid air.¹

In the following decade, the production of electricity from air humidity was verified by several researchers, who used electrodes made with very diverse materials, including protein nanoneedles and graphene surfaces with oxidation gradients.

Different explanations for this phenomenon have emerged, without consensus among authors.² To date, publications in the literature always describe the production of small amounts of energy, which are sufficient only for some small-scale applications, but do not show any prospect of contributing for energy supply, even on a residential scale.

To increase the amount of energy produced, hygroelectric devices were created that incorporate several chemical substances with a depolarizing function, in the two electrodes, as described in WO 2016/019449 A1. The two patents mentioned above attribute the electrification of materials by humid air to the adsorption of ions from atmospheric water, which explains why the materials acquire an electrical charge. When the electrified materials are different close electrical conductors, a charged asymmetric capacitor (made with different electrodes) is formed, which can provide electrical current.

A conductor must have one surface with an acidic nature and the other with a basic nature, for example, an aluminum conductor always has one of its surfaces covered with a thin layer of aluminum oxide, which has an acidic nature.

Conductors made of chromium alloys, such as stainless steel, have a surface covered by a thin layer of chromium oxide, which is a basic oxide.

The hydrogen and hydrogen peroxide formed can be removed from the cell to be used in usual applications, but they can also be used to power a reversible fuel cell inserted between the electrodes of the hygroelectric cell in which they are consumed, releasing more electricity.

This invention is based on a characteristic of hygroelectric cells recently discovered: they also produce hydrogen, hydrogen peroxide and oxygen simultaneously with the production of electricity. This characteristic is unexpected, as it traverses simplistic reasoning supposedly based on thermodynamic arguments.

Water transformation occurs when the reduction of H⁺ ions on the positive electrode and the oxidation of OH⁻ ions on the negative electrode are made possible. Reduction occurs when the positive electrode receives electrons released from the negative electrode, when producing gaseous oxygen. This way, water passes, in a generating device, through the following transformations: ionization, adsorption on the electrodes, and redox reaction of each of the ions, on the respective electrode, producing hydrogen, hydrogen peroxide and oxygen.

These transformations are compatible with the analysis based on Chemical Thermodynamics applied to an open system that features differences in electrical potential within, allowing the input of reactant (water) and the output of reaction products (hydrogen, hydrogen peroxide and oxygen).

### OBJECTIVES OF THE INVENTION

The objective of this invention is the production of energy in a spontaneous process of transforming water, resulting in hydrogen, hydrogen peroxide, oxygen and electrical current.

The implementation of the invention is carried out by constructing and operating devices and equipment powered by water, from which hydrogen, hydrogen peroxide, oxygen and electrical current are extracted simultaneously, in proportions that are determined by the operating parameters. The current state of the art does not feature any device with such characteristics.

The devices constituting this invention are scalable, which enables their application in the industrial production of hydrogen, hydrogen peroxide, oxygen and electrical current.

Another example of equipment is similar to the previous one, but with one difference: the film of insulating material is replaced by a fuel cell that absorbs the hydrogen and peroxide in water and transforms them back into water, producing more electrical current, thus increasing the power produced.

### BRIEF DESCRIPTION OF THE INVENTION

This invention refers to a water decomposition process, which produces hydrogen, hydrogen peroxide, oxygen and electricity and occurs at room temperature and pressure, but also across the entire range of temperatures and pressures in which liquid water exists. The process is implemented in equipment associated with the following characteristics: it has an electrode made with conductive material that acquires a positive charge, when adsorbing H+ions from water; and other electrode made with conductive material that acquires a negative charge, when adsorbing OH ions from the same water. The electrodes are juxtaposed to each other, separated by a film being electrically insulating and allowing water access to the electrode surfaces, as well as the output of reaction products: hydrogen, hydrogen peroxide and oxygen. Therefore, the equipment is characterized as an open and electrically neutral system, that is, containing within it regions with different electrical potentials.

An example of equipment that can be cited is a closed container, which has within it a cell formed by a sandwich of three components, with two electrodes made of different materials separated by a film of an insulating material that can be moistened.

The container has four septa or sockets, one of which is used for the input of electricity conducting wires to connect the cell to an external electrical circuit. A second one is used to collect the gases produced. A third one is used for the input of water or steam and a fourth septum is used for taking samples of gases or liquids from within the container or for injecting reagents.

Another example of equipment that can be used features an open system, in which the cell remains immersed in a container or plant pot. In this case, the hydrogen produced is released directly into the soil, being used to stimulate plant growth.

Finally, in a third example, the cell is immersed in the water of a swimming pool, in which it releases hydrogen peroxide, in order to replace the use of chlorine.

In this Addition document, the hydrogen and hydrogen peroxide formed can be removed from the cell to be used in usual applications, but they can also be used to power a reversible fuel cell inserted between the electrodes of the hygroelectric cell in which they are consumed, releasing more electricity.

### BRIEF DESCRIPTION OF THE DRAWINGS

FIG. 1 is a schematic depiction of the process for simultaneously producing electricity, hydrogen and oxygen from water.

FIG. 2 shows four hygroelectric cells made with aluminum electrodes and graphite-coated Kraft paper, separated by a sheet of filter paper. This generator provided 51 mW of power continuously, feeding a 100 ohm resistor. By cyclically feeding a capacitor, it provided 23 mW of average power and power peaks of 1.2 W.

FIG. 3 shows the electrical current and hydrogen concentration obtained during the operation of a device assembled with aluminum electrodes and a porous PET (polyethylene terephthalate) film coated with exfoliated graphite conductive paint, reassociated and placed inside a 480 mL flask, containing 20 mL of water, wherein the electrical current was measured in a resistor and the H₂ concentration was measured in the air layer.

FIG. 4 shows the electrical current produced by a device as described in claim 1, contained in an open container and exposed to ambient air for ten days. The container received a small amount of water each day.

FIG. 5 shows the increase in electrical current produced in the process described in claim 6, showing the effect of adding small amounts of sodium bisulfite.

FIG. 6 shows, on the left, an equipment for simultaneously producing electricity, hydrogen and oxygen or hydrogen peroxide and, on the right, the top view of the equipment.

FIG. 7 illustrates the image of a hygroelectric cell in a pot for growing plants, simultaneously producing electricity, hydrogen and oxygen or hydrogen peroxide.

FIG. 8 shows the ratio of hydrogen concentration, time and current/power/temperature in the process for simultaneously producing hydrogen, electricity, hydrogen peroxide and oxygen from water.

FIG. 9 illustrates an assembly diagram of a hygroelectric cell with a fuel cell inserted.

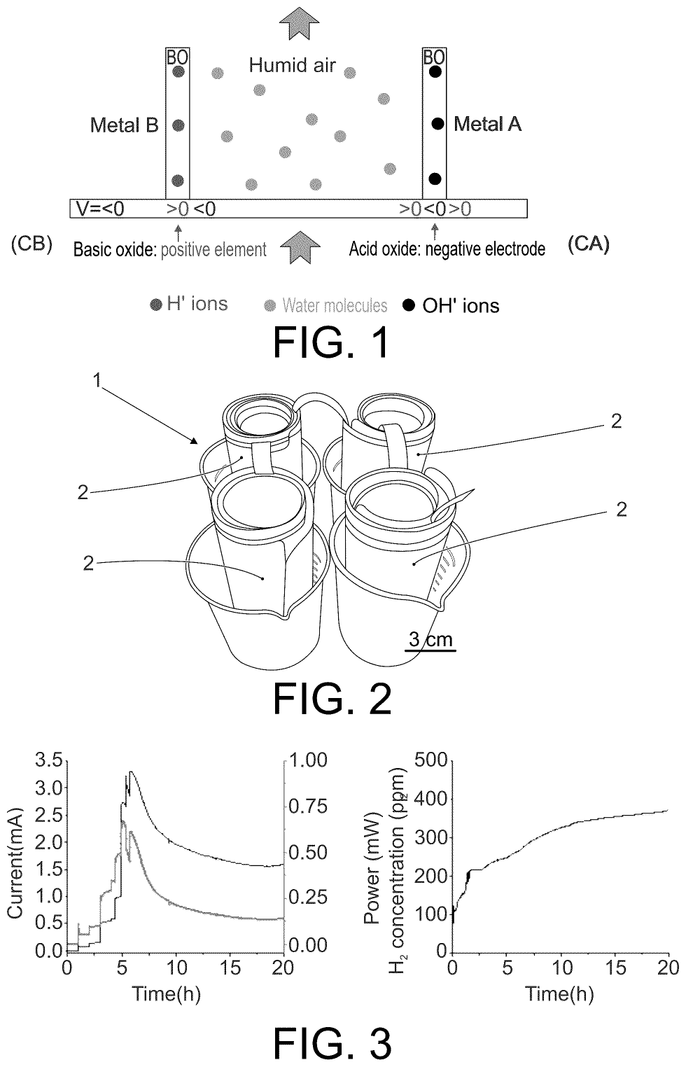

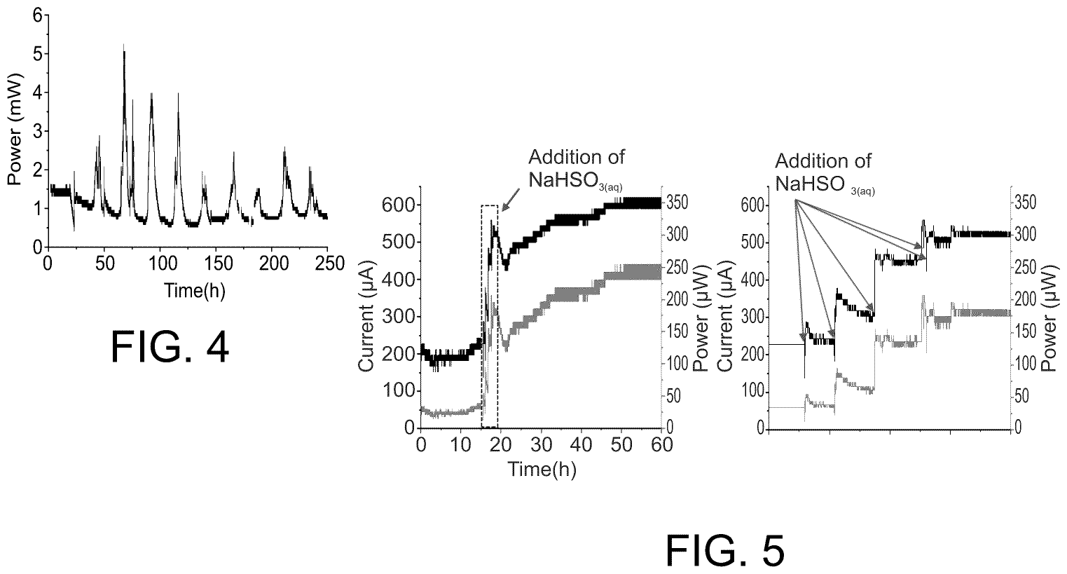

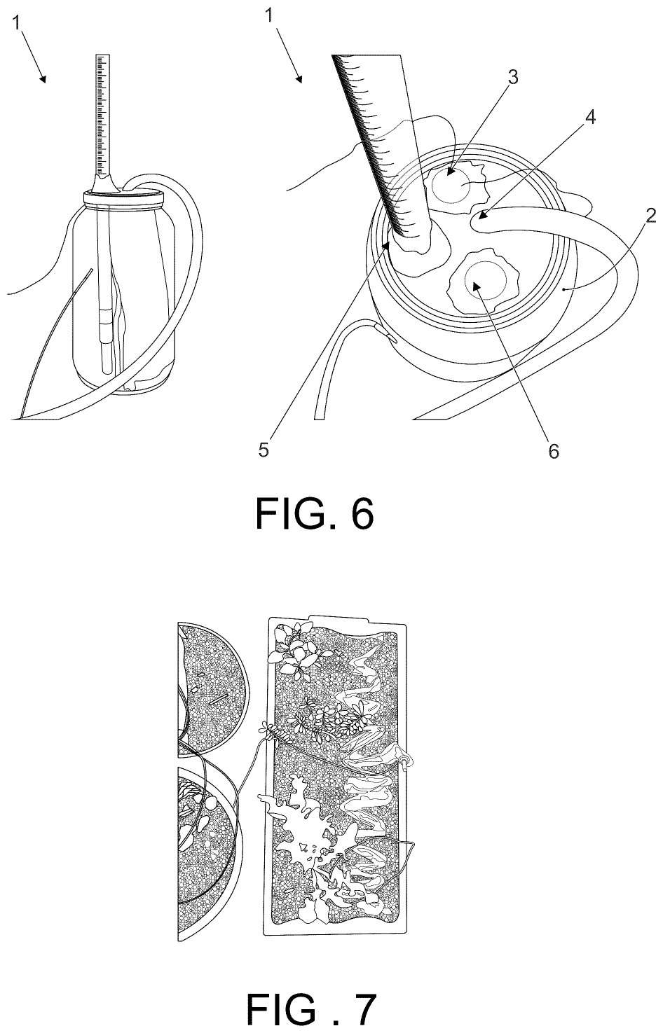

### NUMERICAL REFERENCES

(1) Equipment.
(2) Base or body.
(3) Wires input/output from cell to circuit.
(4) Water (4) or steam input pipe.
(5) Opening for collecting gases or exiting the hydrogen, hydrogen peroxide and oxygen produced.
(6) Opening.
(CA) Acid conductor.
(CB) Basic conductor.
(HG) Hygroelectric cell.
(CC) Fuel cell.
(P) Paper.
(E) Erg in TNT.
(A) Aluminum.

### DETAILED DESCRIPTION OF THE INVENTION

In this invention, hydrogen, hydrogen peroxide and oxygen are formed in electrodes, in a way similar to what happens in an electrolytic cell, but without requiring the provision of external electrical energy. Neither this process nor the equipment has previously been described in scientific or technical literature, or in patents, in any way.

The equipment (1) for introducing water comprises a base or body (2), provided with wires input/output (3) from cell to circuit, water or steam input tube (4), an opening (5) for collecting gases or exiting the hydrogen, hydrogen peroxide and oxygen produced, which can be made continuously or under operator control, and an opening (6) for collecting samples from the reactor or introducing reagents.

The examples demonstrate hydrogen production simultaneously with hydrogen peroxide production, which was verified using hydrogen sensors and also gas chromatography.

Whenever the priority in using the equipment is the production of electricity, the hydrogen and hydrogen peroxide or oxygen produced by the hygroelectric cell can be consumed in situ, feeding a fuel cell inserted between the electrodes of the hygroelectric cell. The electrical current generated by the fuel cell increases the total power produced by the device and eliminates emissions of hydrogen and hydrogen peroxide or oxygen to the outside of the hygroelectric cell.

The use of the electricity thus produced can be done in any way known in the art, whether by using the electrical current obtained to feed an electrical or electronic circuit, by storing the electricity in batteries or capacitors or further by supplying electrical current to carry out another electrochemical process, or by activating lights, motors or communication systems.

The hydrogen, hydrogen peroxide and oxygen obtained can be separated or recovered using any process known in the art, such as, for example, cryogenic separation and hydrogen recovery using palladium membranes, which are widely used industrially. It is still possible to consider other gas capture processes, such as the formation of clathrates.

Hydrogen can be used as an energy vector and as a fuel, as an industrial raw material, and can be directly used in agriculture³ and in medical applications,⁴ two fields in which it finds numerous applications that currently arouse great interest. Oxygen has numerous practical applications in industrial processes, in hospitals and in any combustion process.

Generating devices can be connected parallel or in series to achieve the voltages or electrical currents required by the different applications, as shown in the figures.

In addition to the matter previously described, some details are necessary so that the process for simultaneously producing hydrogen, electricity, hydrogen peroxide and oxygen works perfectly and features a satisfactory yield.

Initially, an electrical conductor must have a surface with an acidic nature (CA) and another with a basic nature (CB), for example, an aluminum conductor always has a surface covered with a thin layer of aluminum oxide, which provides an acidic nature (CA). Conductors made of chromium alloys, such as stainless steel, have a surface covered by a thin layer of chromium oxide, which is a basic oxide (CB).

The quantity of each product formed can vary through the control of operating parameters; however, there is no way to measure specific values for this, as the quantities of each product formed depend on a large number of parameters, such as the equipment (1) size, the operating temperature, the electrical energy consumed in the external circuit, the electrode area, the composition of gases and liquids contained in the equipment (1), among others.

In the equipment (1) in which the process is performed, the electrodes are characterized by the ability to spontaneously electrify, that is, by presenting a voltage or difference in electrical potential.

This electrical potential difference measured depends on the materials used as electrodes, the thickness of the insulating layer separating the electrodes, the pH of the water and the presence of other oxidizing or reducing substances in the system.

By considering the several cases already studied, a range between 0.5 and 1.58 V was obtained under open circuit conditions, that is, without draining electrical current.

In the same way, as previously explained, when the equipment is used in the production of electricity, the hydrogen and hydrogen peroxide or oxygen produced by the hygroelectric cell can be consumed in situ, by feeding a fuel cell inserted between the electrodes of the hygroelectric cell.

The equipment (1) contains tubes (4) for introducing water, and the opening (5) of the hydrogen, hydrogen peroxide and oxygen produced can be done continuously or under operator control and the devices for introducing water, removing hydrogen and electrical current can be located in many positions.

The equipment (1) increases the formation rates of hydrogen, electricity, hydrogen peroxide and oxygen when heated by any means known in the art, and, as it is a chemical reaction, this increase in rates depends on temperature variation and other operating parameters.

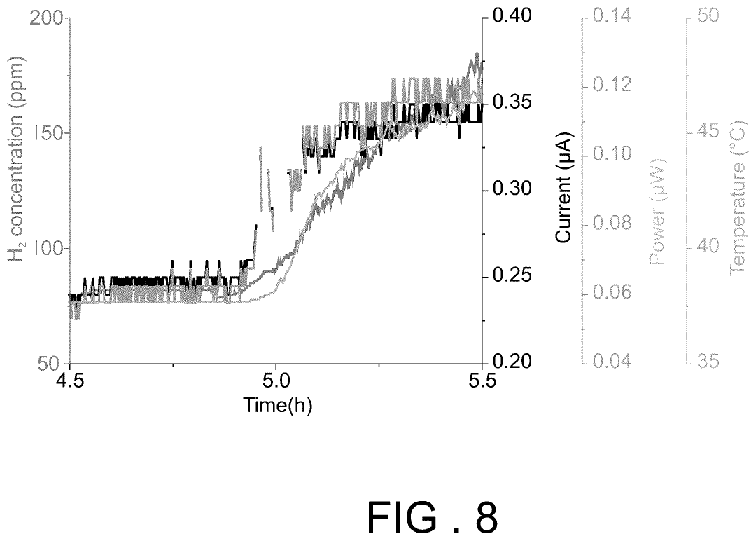

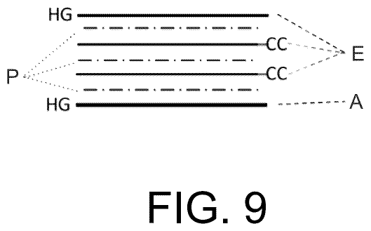

An example is given in FIG. 8, which shows that an increase of 9° C. in operating temperature caused an increase of 40% in electrical current, 100% in electrical power and 113% in the H₂ concentration produced in an aluminum and ERG hygroelectric cell (HG) with an area of 0.02 m².

The equipment (1) provides hydrogen, hydrogen peroxide, oxygen and electricity in controlled proportions set between two limits: the limit corresponding to the maximum oxygen is 1 mole of hydrogen, ½ mole of oxygen and 2 moles of electrons and the limit corresponding to the minimum oxygen is 1 mole of hydrogen, 1 mole of hydrogen peroxide and 2 moles of electrons.

The process for simultaneously producing hydrogen, electricity, hydrogen peroxide and oxygen from water, according to the application BR 10 2022 012851 0, uses water as the only input and is based on the reaction of hydrogen abstraction from water, accompanied by the formation of hydrogen peroxide or oxygen, and occurs in a humid/aqueous environment, which contains two electrical conductors separated, but electrically connected to an electrical circuit, and this Certificate of Addition—C1 is characterized by the in situ consumption of hydrogen, hydrogen peroxide and oxygen in a fuel cell (CC).

It also has the important feature of containing within it a fuel cell (CC) that transforms hydrogen, hydrogen peroxide and oxygen into water and also produces electrical current, thus increasing the power generated by the equipment.

In this process, producing only electrical current from the equipment is obtained by feeding a fuel cell (CC) with the hydrogen, hydrogen peroxide and oxygen initially formed.

The set is made up of seven overlapping sheets, one of them made of aluminum (A), three made of ERG and three made of paper (P). At the ends, the sheets form the hygroelectric cell (HG) and the two ERG sheets in TNT (E) form the fuel cell (CC).

### BIBLIOGRAPHIC REFERENCES

1—Telma R. D. Ducati, Luís H. Simões, and Fernando Galembeck, Charge Partitioning at Gas-Solid Interfaces: Humidity Causes Electricity Buildup on Metals, Langmuir 2010, 26, 17, 13763-13766.
2—Xuezhong Zhang, Xin Chen, Yuliang Qu, Yanan Wu, Kai Wu, Hua Deng, Qiang Fu, Fabricating high performance multi-functional hygroelectric generator through biomimic approach, Energy, 98, a Nano 2022, 107241, https://doi.org/10.1016/j.nanoen.2022.107241. D. Shen, W.W. Duley, P. Peng, M. Xiao, J. Feng, L. Liu, G. Zou, Y. N. Zhou, Moisture-enabled electricity generation: from physics and materials to self-powered applications, Adv. Mater., 32 (2020), pp. 1-31, 10.1002/adma.202003722. X. Nie, J. Bingxue, N. Chen, Y. Liang, Q. Han, L. Qu, Gradient doped polymer nanowire for moistelectric nanogenerator, Nano Energy, 46 (2018), pp. 297-304, 10.1016/j.nanoen.2018.02.012. Nie, J. Bingxue, N. Chen, Y. Liang, Q. Han, L. Qu, Gradient doped polymer nanowire for moist electric nanogenerator, Nano Energy, 46 (2018), pp. 297-304, 10.1016/j.nanoen.2018.02.012. Xuezhong Zhang, Xin Chen, Yuliang Qu, Yanan Wu, Kai Wu, Hua Deng, Qiang Fu, Fabricating high performance multi-functional hygroelectric generator through a biomimic approach, Nano Energy, 98, 2022, 107241, https://doi.org/10.1016/j.nanoen.2022.107241.
3—Zulfiqar, F., Russell, G. & Hancock, J. T. Molecular hydrogen in agriculture. Planta. 254, 56 (2021). https://doi.org/10.1007/s00425-021-03706-0
4—Ichihara M, Sobue S, Ito M, Ito M, Hirayama M, Ohno K. Beneficial biological effects and the underlying mechanisms of molecular hydrogen-comprehensive review of 321 original articles. Med Gas Res. 2015; 5 :12. Published 2015 Oct. 19. doi: 10.1186/s13618-015-0035-1).

1. “PROCESS FOR SIMULTANEOUSLY PRODUCING HYDROGEN, ELECTRICITY, HYDROGEN PEROXIDE AND OXYGEN FROM WATER”, wherein water is used as the only input and wherein it is based on the reaction of hydrogen abstraction from water, accompanied by the formation of hydrogen peroxide or oxygen, and occurs in a humid/aqueous environment, which contains two electrical conductors separated, but electrically connected to an electrical circuit.

2. “PROCESS FOR SIMULTANEOUSLY PRODUCING HYDROGEN, ELECTRICITY, HYDROGEN PEROXIDE AND OXYGEN FROM WATER”, according to claim 1, wherein one conductor has a surface with an acidic nature (CA) and the other conductor has a basic nature (CB) of the substances present on the surfaces of the two electrical conductors.

3. “PROCESS FOR SIMULTANEOUSLY PRODUCING HYDROGEN, ELECTRICITY, HYDROGEN PEROXIDE AND OXYGEN FROM WATER”, according to claim 1, wherein varying the quantity of each product formed through the control of operating parameters is possible.

4. “PROCESS FOR SIMULTANEOUSLY PRODUCING HYDROGEN, ELECTRICITY, HYDROGEN PEROXIDE AND OXYGEN FROM WATER”, according to claim 3, wherein hydrogen, hydrogen peroxide and oxygen are consumed in situ in a fuel cell.

5. “PROCESS FOR SIMULTANEOUSLY PRODUCING HYDROGEN, ELECTRICITY, HYDROGEN PEROXIDE AND OXYGEN FROM WATER”, according to claims 1 to 3, wherein the production of hydrogen and electricity in the presence of reducing substances is intensified.

6. “PROCESS FOR SIMULTANEOUSLY PRODUCING HYDROGEN, ELECTRICITY, HYDROGEN PEROXIDE AND OXYGEN FROM WATER”, according to claim 5, wherein it uses at least one substance from the group including the following reducing substances: sulfites, sulfides, phosphites, iodides, bromides, chlorides, hydrides, salts of iron (II), manganese (II), copper (I), ascorbic acid, reducing sugars, reducing organic acids and alcohols, among others.

7. “PROCESS FOR SIMULTANEOUSLY PRODUCING HYDROGEN, ELECTRICITY, HYDROGEN PEROXIDE AND OXYGEN FROM WATER”, according to claim 5, wherein the reducing substances are municipal or industrial effluents or other contaminants of natural or reused water or also reducing gases, such as sulfur dioxide or carbon monoxide.

8. “PROCESS FOR SIMULTANEOUSLY PRODUCING HYDROGEN, ELECTRICITY, HYDROGEN PEROXIDE AND OXYGEN FROM WATER”, according to claims 1 to 3, wherein the intensification of the production of hydrogen and electricity takes place in the presence of catalysts from the decomposition of hydrogen peroxide forming oxygen and water.

9. “PROCESS FOR SIMULTANEOUSLY PRODUCING HYDROGEN, ELECTRICITY, HYDROGEN PEROXIDE AND OXYGEN FROM WATER”, according to claim 6, wherein one or more of the hydrogen peroxide decomposition catalysts are included: manganese dioxide, silver, platinum, iron (III) salts, iodides and peroxidase enzymes.

10. “PROCESS FOR SIMULTANEOUSLY PRODUCING HYDROGEN, ELECTRICITY, HYDROGEN PEROXIDE AND OXYGEN FROM WATER”, according to claims 7 and 9, wherein the control of the proportion between hydrogen peroxide and oxygen produced takes place through the use of catalysts.

11. “PROCESS FOR SIMULTANEOUSLY PRODUCING HYDROGEN, ELECTRICITY, HYDROGEN PEROXIDE AND OXYGEN FROM WATER”, according to claim 5, wherein hydrogen peroxide, in oxidation reactions that lead to the formation of other chemicals, is consumed in situ.

12. “PROCESS FOR SIMULTANEOUSLY PRODUCING HYDROGEN, ELECTRICITY, HYDROGEN PEROXIDE AND OXYGEN FROM WATER”, according to claim 5, wherein hydrogen peroxide, as an initiator of polymerization reactions, is consumed in situ.

13. “EQUIPMENT”, for performing the process according to claims 1 to 12, wherein the electrodes have the ability to spontaneously electrify, as they have a voltage or difference in electrical potential when exposed to liquid water or steam.

14. “EQUIPMENT”, according to claim 13, wherein it features an equipment (1) for introducing water, comprising a base or body (2) provided with wires input/output (3) from cell to circuit, water or steam input tube (4), an opening (5) for collecting gases or exiting the hydrogen, hydrogen peroxide and oxygen produced, and an opening (6) for collecting samples from the reactor or introducing reagents.

15. “EQUIPMENT”, according to claims 13 and 14, wherein the opening (5) for collecting gases or exiting the hydrogen, hydrogen peroxide and oxygen produced is made continuously.

16. “EQUIPMENT”, according to claims 13 and 14, wherein it contains within it a fuel cell that transforms hydrogen, hydrogen peroxide and oxygen into water and also produces electrical current, thus increasing the power generated by the equipment.

17. “EQUIPMENT”, according to claims 13 and 14, wherein the opening (5) for collecting gases or exiting the hydrogen, hydrogen peroxide and oxygen produced is made under the operator control.

18. “EQUIPMENT”, according to claims 13, 14, 15 and 17, wherein it goes into operation automatically when fed with water in any form: liquid, vapor, solid, aerosol or supercritical or even in the form of an aqueous dispersion or solution.

19. “EQUIPMENT”, according to claims 13, 14, 15 and 17, wherein it operates in the temperature range between 0 and 150° C.

20. “EQUIPMENT”, according to claims 13 and 18, wherein it increases the formation rates of hydrogen, electricity, hydrogen peroxide and oxygen when heated.

21. “EQUIPMENT”, according to claims 13 and 20, wherein the materials used in the electrodes have an electricity conducting nature.

22. “EQUIPMENT”, according to claims 13 and 21, wherein the acid-base properties of the electrodes surface, which causes their electrification, have a difference.

23. “EQUIPMENT”, according to claims 3 and 22, wherein the difference in the acid-base properties of the electrodes is intrinsic to the material, such as the presence of oxides on metallic surfaces, cations interleaving in lamellar compounds or even the adsorption of ions from water on the surface of the material.

24. “EQUIPMENT”, according to claims 13 and 23, wherein it requires only the presence of water, in any form (liquid, vapor or ice) and may contain contaminants, including water collected from rain, from bodies of water in the environment and wastewater or effluents, but eliminating the use of any liquid or solid electrolyte between the electrodes.

25. “EQUIPMENT”, according to claims 13 and 24, wherein it is made with metallic electrodes, such as steel and other iron alloys, aluminum and alloys thereof, other metals and alloys thereof, or with non-metallic conductors and semiconductors, such as graphite and other forms of carbon, phosphorus, arsenic, silicon and germanium and derivatives thereof or with electricity conducting synthetic polymers, and composite materials produced with conductors and semiconductors may also be used.

26. “EQUIPMENT”, according to claims 13 and 25, wherein it provides hydrogen, hydrogen peroxide, oxygen and electricity in proportions controlled by the operating parameters, including temperature, pressure, resistance of the circuit connected to the electrodes, and the presence of activating substances, including catalysts for reactions in the electrodes, reducing or oxidizing substances or even catalysts for chemical reactions of hydrogen peroxide; the operating parameters defined by the limit corresponding to the maximum oxygen is 1 mole of hydrogen, ½ mole of oxygen and 2 moles of electrons and the minimum oxygen is 1 mole of hydrogen, 1 mole of hydrogen peroxide and 2 moles of electrons.

27. “EQUIPMENT”, according to claims 13 and 26, wherein it is optimized for producing only one of the following products: hydrogen or hydrogen peroxide or electrical current.

28. “EQUIPMENT”, according to claim 27, wherein the production of only electrical current is obtained by feeding a fuel cell with the hydrogen, hydrogen peroxide and oxygen initially formed.

29. “EQUIPMENT”, according to claims 13 and 27, wherein it includes devices for hydrogen purification, such as, for example: membranes, cryogenic separators and clathrates.
